(19) United States
(12) Patent Application Publication
(10) Pub. No.: US 2024/0138625 A1
(43) Pub. Date: May 2, 2024

(54) COOKING DEVICE

(71) Applicant: TIGER CORPORATION, Osaka (JP)

(72) Inventor: Takafumi OBATA, Osaka (JP)

(73) Assignee: TIGER CORPORATION, Osaka (JP)

(21) Appl. No.: 18/277,999

(22) PCT Filed: Mar. 31, 2022
(86) PCT No.: PCT/JP2022/016562

§ 371 Date: Aug. 20, 2023

(30) Foreign Application Priority Data
Apr. 1, 2021 (JP) 2021-062916

(51) Int. Cl. A47J 43/07; A47J 43/046

(52) U.S. Cl. CPC A47J 43/0727; A47J 43/046; A47J 43/0766; A47J 43/0772

(57) ABSTRACT

Provided is a cooking device in which a cooking container can be attached to and detached from a body in a non-vertical direction. A cooking device according to the present invention includes: a cooking container that has a cooking implement and that is equipped with a cup to which a lid can be attached, and a body to which the cooking container is attached and which causes the cooking implement to rotate. The cooking container is configured to be attached to and detached from the body in a non-vertical direction. The cooking implement has a rotation center that is inclined in a non-vertical direction when the cooking container is kept attached to the body. The body is capable of causing the cooking implement rotate about a non-vertical axis.

### BACKGROUND

### Technical Field

The present invention relates to a cooking device equipped with a rotating cooking implement, such as a mixer, juicer, or food processor, and more particularly to a cooking device in which a cooking container may be detachably attached to the body from a non-vertical direction.

### Related Art

In cooking devices such as mixers, juicers, and food processors, the cooking container is arranged on the body, and a cooking implement having a blade is rotated inside the cooking container to perform cooking tasks such as crushing, mincing, grating, mashing, chopping, or stirring food ingredients (for example, see Patent Literature 1).

The cooking container is configured by closing a cup into which food ingredients are placed with a lid.

### CITATION LIST

### Patent Literature

[Patent Literature 1] Patent Literature 1: JP 11-28165

### SUMMARY

### Technical Problem

To attach and detach a cooking container to and from a body, the cooking container must be lifted upward by a predetermined height or more from the body. However, lifting the cooking container is not easy because its weight increases due to food ingredients.

Moreover, it is necessary to cook with the lid attached to the cup in the cooking container, but if the attachment of the lid is forgotten, there is a risk that food ingredients may scatter during cooking. Although not described in Patent Literature 1, in order to detect whether or not a lid is attached, it is necessary to deploy a sensor that detects the lid on the handle of the cup and to detect it with the body. The arrangement of such a sensor also leads to an increase in the weight of the cooking container.

An object of the present invention is to provide a cooking device in which a cooking container may be detachably attached to the body from a non-vertical direction.

### Solution to Problem

The cooking device includes:
a cooking container that has a cooking implement and that is equipped with a cup to which a lid is attachable; and
the body on which the cooking container is mounted and which rotates the cooking implement,
the cooking container is attached to and detached from the body in a non-vertical direction.

The cooking container may be attachable and detachable with respect to the body in a non-vertical direction of 0° to 75° relative to a horizontal direction.

The body may have a lock mechanism that prevents the cooking container from falling off and/or being displaced.

The body may have an installation detection device that detects that the body is separated from a placement surface while the cooking implement is rotating.

The rotation center of the cooking implement is inclined in a non-vertical direction with the cooking container attached to the body, and
the body may rotate the cooking implement about a non-vertical axis center.

The cooking container may have a configuration in which an upper edge side extends in a vertical direction.

The body may have a lid detection device that detects the lid with the cooking container attached.

A buffer member may be provided between the body and the cooking container to prevent the cooking container from being excessively pushed with respect to the body in a non-vertical direction.

The cooking container has a spout with an upper edge protruding outward, and
a bottom surface of the cooking container may have two contact edges that, when the cooking container is tilted toward the spout from a state of being placed on a placement surface, come into contact with the placement surface.

### Effects

According to the cooking device of the present invention, the cooking container may be attached and detached in a non-vertical direction with respect to the body, thus the attachment operation of the cooking container can be easily performed even if the cooking container becomes heavier due to the food ingredients. Moreover, by rotating the cooking implement about a non-vertical axis center, it is possible to suppress the progression of oxidation of the food ingredients and further suppress heat generation due to friction of the food ingredients, thereby preventing deterioration of the food ingredients.

### BRIEF DESCRIPTION OF THE DRAWINGS

FIG. 1 is a perspective view showing an appearance of a mixer, which is a cooking device according to one embodiment of the present invention.

FIG. 2 is a right side view of the mixer.

FIG. 3 is a front view of the mixer.

FIG. 4 is a cross-sectional view taken along line A-A of FIG. 3.

FIG. 5 is a perspective view showing a state in which the cooking container is detached from the body.

FIG. 6 is a cross-sectional view of FIG. 5.

FIG. 7 is a perspective view of the cooking container.

FIG. 8 is a rear view of the cooking container.

FIG. 9 is a cross-sectional view taken along line C-C of FIG. 8.

FIG. 10 is a view of the cooking container as seen from arrow D direction in FIG. 9.

FIG. 11 is a perspective view of the cooking container with a cutter die removed from a cup.

FIG. 12 is a rear view of the cooking container with a cutter die removed from a cup.

FIG. 13 is a perspective view of the cutter die.

FIG. 14 is a plan view of the cutter die.

FIG. 15 is a side view of the cutter die.

FIG. 16 is a cross-sectional view taken along line F-F of FIG. 15.

FIG. 17 is a diagram showing the attachment and detachment states of the cup and the cutter die, where (a) shows the detachable state of the cutter die, (b) shows the state during attachment and detachment, and (c) shows the attached state.

FIG. 18 is a cross-sectional view showing an intermediate state of attaching the cooking container to the body.

FIG. 19 is an explanatory diagram showing a state in which the body and the cutter die are engaged with each other by engagement portions so as to be incapable of relative rotation.

FIG. 20 is an explanatory diagram showing a state in which the engagement portions are misaligned by 5° when the cutter die engages with the body.

FIG. 21 is an explanatory diagram of the mixer showing a state in which a cutter die-side engagement portion rotates from the state of FIG. 20, and the engagement portions are engaged with each other.

FIG. 22 is a cross-sectional view of a mixer showing a state in which the cooking container is attached to the body without the lid.

FIG. 23 is an explanatory diagram showing (a) a movement direction of food ingredients when cooked using the inclined cutter shaft of the present invention, and (b) a movement direction of food ingredients when cooked using a cutter shaft in the vertical direction.

FIG. 24 is a cross-sectional view of the mixer showing a state in which a part is inclined and separated from the placement surface.

FIG. 25 is an explanatory diagram showing a step of tilting the cooking container with the contact edge as a fulcrum when pouring out food ingredients.

FIG. 26 is a bottom perspective view of the cutter die showing a modified example of the finger hook portion.

### DESCRIPTION OF THE EMBODIMENTS

An explanation will be given with reference to the drawings for the cooking device of the present invention. It should be noted that although a mixer 10 is exemplified and described as the cooking device, any cooking device that rotates a cooking implement to cook food ingredients may be used, not limited to the mixer 10, such as a food processor, juicer, mill, or blender.

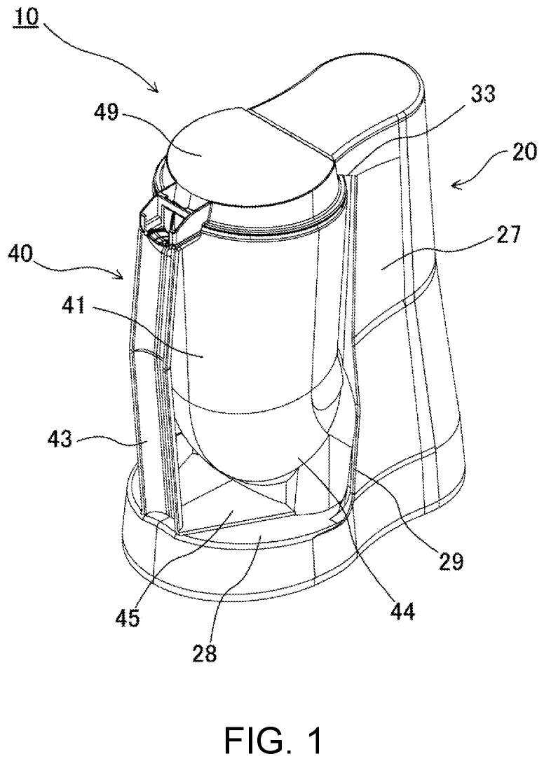

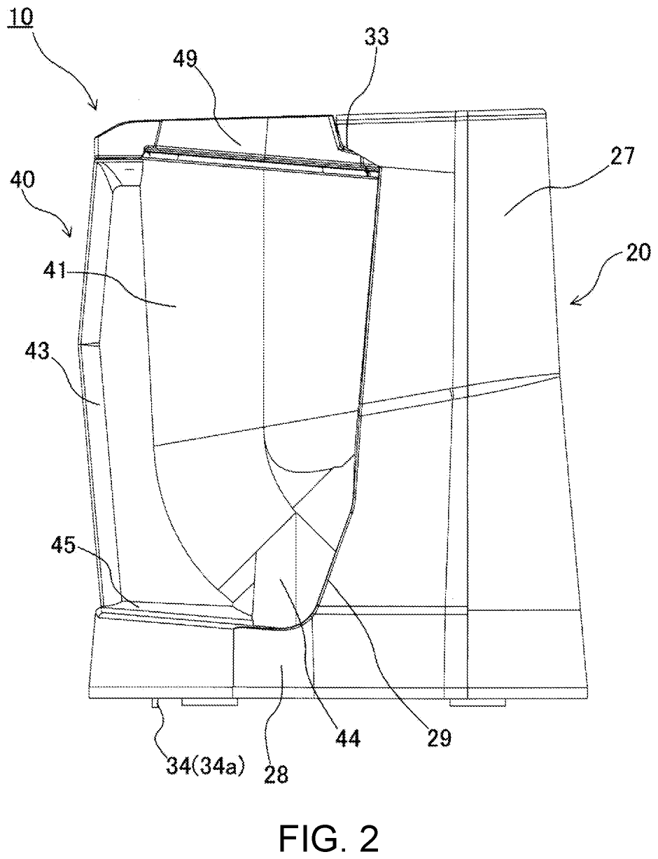

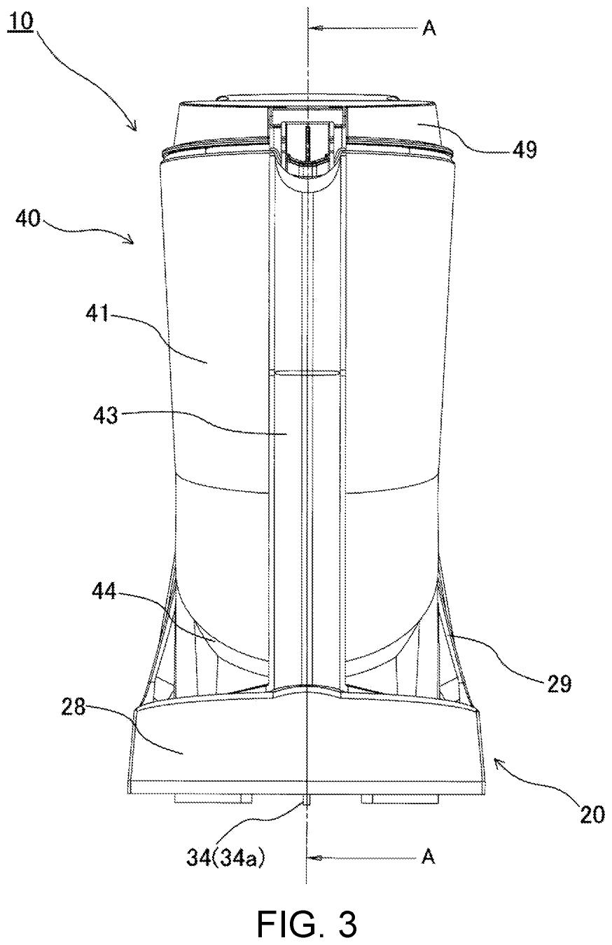

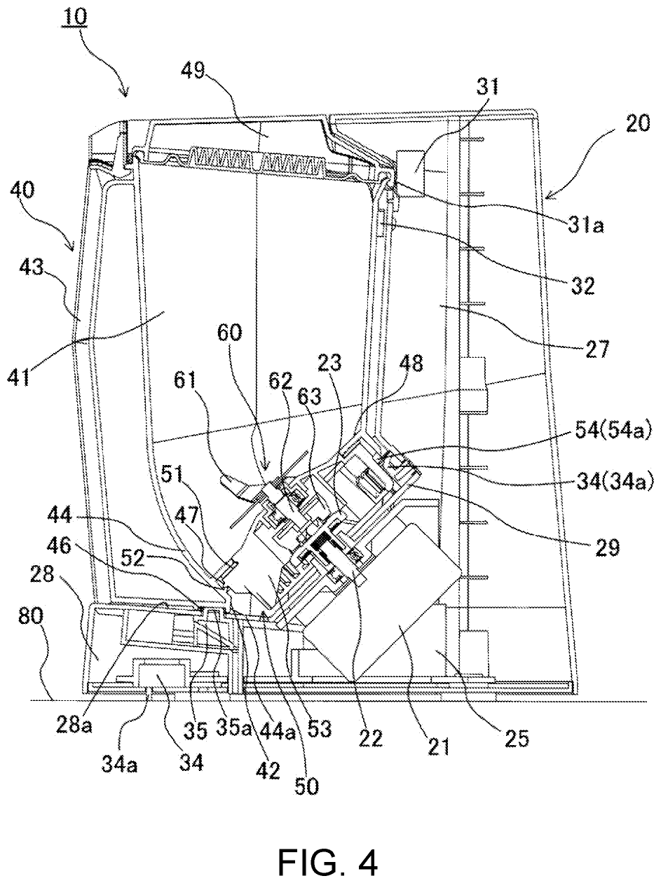

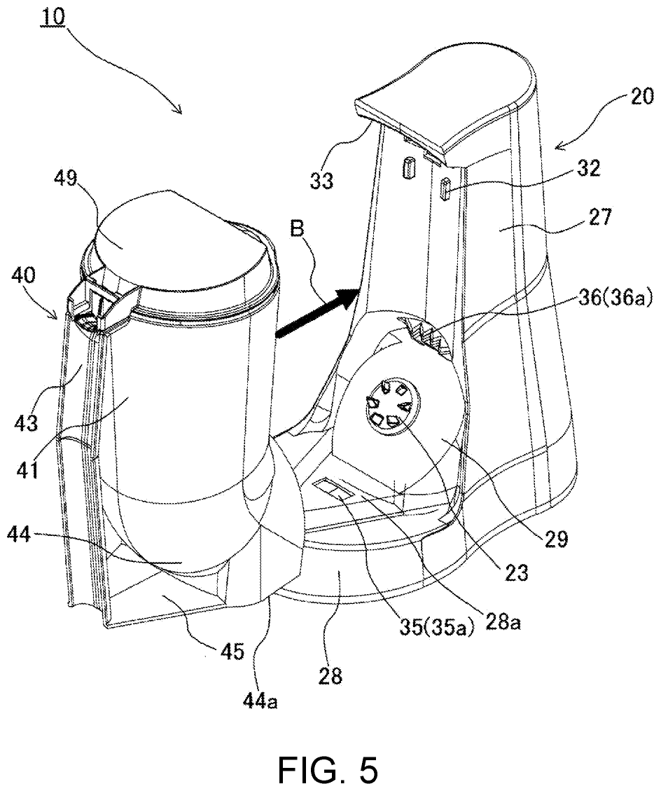

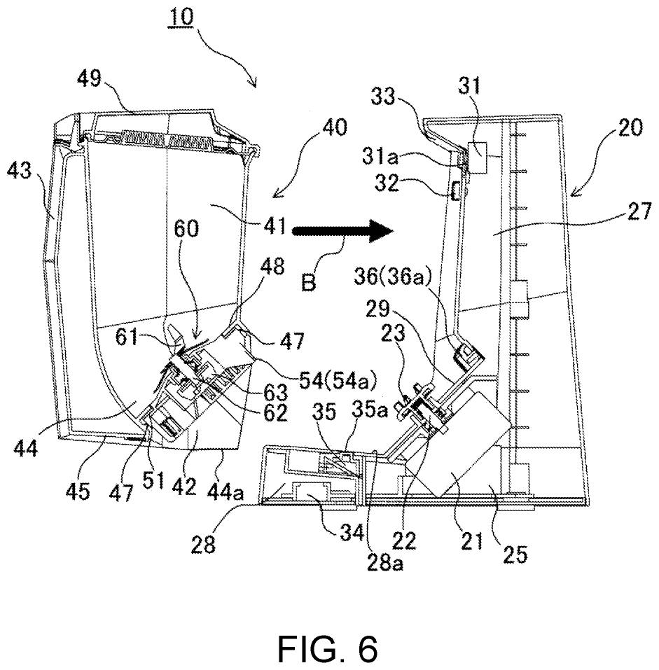

FIG. 1 is a perspective view showing the overall configuration of a mixer 10 according to one embodiment of the present invention, FIG. 2 is a right side view, FIG. 3 is a front view, and FIG. 4 is a cross-sectional view taken along line A-A of FIG. 3. Moreover, FIG. 5 is a perspective view showing a state in which a cooking container 40 is detached from a body 20, and FIG. 6 is a cross-sectional view thereof.

As shown in FIG. 1 and the like, the mixer 10 includes the body 20 and the cooking container 40 mounted on the upper portion of the body 20. In this embodiment, the mixer 10 is configured such that the body 20 is located on the right side (rear side) in the right side view of FIG. 2, and the cooking container 40 is located on the upper left side (front upper side). The cooking container 40 may be attached to and detached from the body 20 by approaching and separating in a non-vertical direction (approximately horizontal direction in the drawing) as indicated by arrow B in FIGS. 5 and 6. The non-vertical direction for attaching and detaching the cooking container 40 is preferably between 0° and 75° with respect to the horizontal direction, and more desirably between 0° and 60°.

The body 20 includes a vertical portion 27 that extends to approximately the same height as the cooking container 40, a horizontal portion 28 that extends substantially parallel to a placement surface 80 formed directly below the cooking container 40, and an inclined portion 29 that connects the vertical portion 27 and the horizontal portion 28. In the drawing, the inclination angle of the inclined portion 29 is set to approximately 45°, but it is not limited thereto. Furthermore, the body 20 may be configured without the horizontal portion 28 and composed of only the vertical portion 27 and the inclined portion 29.

As shown in FIGS. 5 and 6, the inclined portion 29 may be formed with a concave shape such that its upper end side intrudes into the vertical portion 27. As shown in FIGS. 4 to 6, a body-side coupling 23, which connects to a cooking implement 60 to be described later, protrudes from the inclined portion 29. The body-side coupling 23 is connected to an output shaft 22 of a motor 21 shown in FIGS. 4 and 6 and may rotate by the driving of the motor 21. In the illustrated embodiment, a direct-drive structure is adopted in which the output shaft 22 of the motor 21 is directly connected to the body-side coupling 23, but it is also possible to configure the body-side coupling 23 to be connected to the motor 21 through a speed reduction mechanism such as gears or belts.

Furthermore, a body-side engagement portion 36, which engages with the cutter die-side engagement portion 54 of a cutter die 50, is formed on the upper edge side of the inclined portion 29. The body-side engagement portion 36 will be described later.

An upper surface 28a of the horizontal portion 28 is inclined downward by 5° toward the right side, i.e., the rear side, in FIGS. 4 and 6, so as to be able to guide a bottom surface 44a of the cooking container 40. Also, on the lower surface side of the horizontal portion 28, an installation detection device 34 for detecting tilting and lifting of the mixer 10 is arranged as shown in FIG. 4, and a lock mechanism 35 for preventing the cooking container 40 from falling off is arranged on the upper surface 28a side.

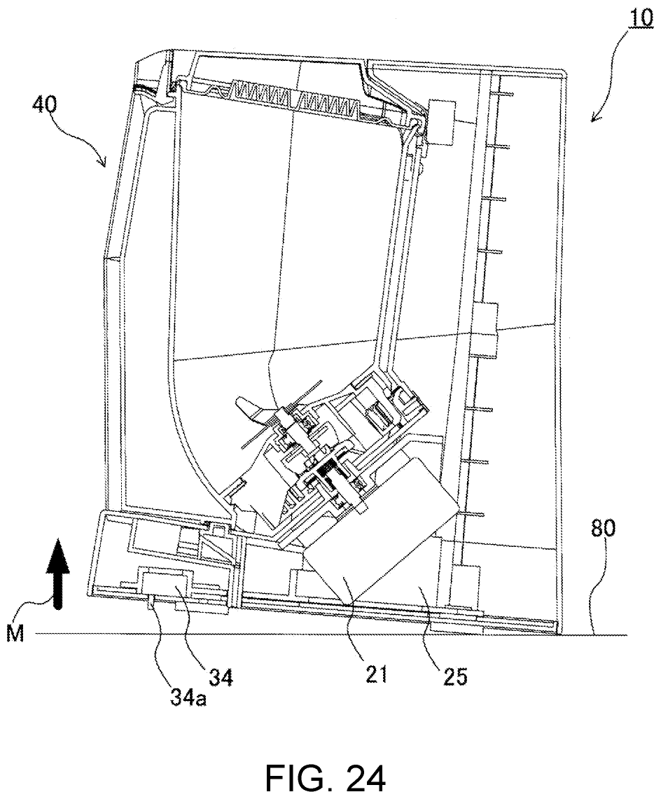

The installation detection device 34, for example, is a switch with a retractable operation member 34a, and the operation member 34a retracts from the lower surface of the body 20 by the urging of a spring or the like (see FIG. 4 and FIG. 24 to be described later). The installation detection device 34 may be an infrared sensor or the like.

The lock mechanism 35, for example, is a claw piece 35a that may retract upward from the horizontal portion 28 by a solenoid or the like. Of course, the lock mechanism 35 may also be configured from a cam, spring, link, etc. In the illustrated embodiment, the lock mechanism has the claw piece 35a protruding from the horizontal portion 28 and fitting into a receiving portion 46 of the cooking container 40 to be described later, thereby preventing the cooking container 40 from falling off or displaced in position by engaging it with the body 20.

Furthermore, the upper end side of the vertical portion 27 is provided with a lid detection device 31 (see FIGS. 4 and 6) for detecting a lid 49 of the cooking container 40. The lid detection device 31 detects that the lid 49 of the cooking container 40 is correctly positioned at a predetermined position on the vertical portion 27. As a result, that the cooking container 40 is correctly positioned on the body 20, and furthermore, that the lid 49 is correctly mounted on the cooking container 40 are determined. For example, the lid detection device 31 may be exemplified by a switch with a retractable operation member 31a or an infrared sensor. In the case of a retractable switch, as shown in FIGS. 4 and 6, the retractable transition path of the operation member 31a is set to be at the height of the lid 49. By providing the lid detection device 31 on the body 20 side instead of the cooking container 40, there is an advantage of preventing an increase in weight of the cooking container 40.

Moreover, on the vertical portion 27, below the lid detection device 31 described above, there is arranged a buffer member 32 made of rubber, urethane, sponge, or the like. The buffer member 32 prevents the vertical portion 27 from strongly contacting the body portion of the cooking container 40 when the cooking container 40 is excessively pushed when the cooking container 40 is placed on the body 20 and also relieves the impact. It should be noted that the buffer member 32 may also be arranged in the cooking container 40.

Furthermore, the vertical portion 27 itself has a guide portion 33 protruding toward the front side, that is, the cooking container 40 side, at its upper end. The guide portion 33 comes into contact with the upper surface of the lid 49 of the cooking container 40 and guides the cooking container 40 to be installed on the body 20 at the correct attachment angle. As a result, even if one tries to attach the cooking container 40 to the body 20 at an incorrect angle, such as tilted upward or downward, the lid 49 comes into contact with the guide portion 33 and the entry angle is regulated, allowing the cooking container 40 to be mounted at the correct attachment angle. In the drawing, the tip of the lid 49 is made concave in shape so as to be easily guided by the guide portion 33, and if the mounting direction of the lid 49 is incorrect, the lid 49 comes into contact with the guide portion 33, making it impossible to mount the cooking container 40.

Among the mechanisms described above, the motor 21, the installation detection device 34, the lock mechanism 35, and the lid detection device 31 are electrically connected to a control unit 25 (see FIG. 4 and the like) housed in an appropriate location within the body 20. The control unit 25 is connected to a switch (not shown) provided on the outer surface of the body 20, and various functions of the mixer 10 are activated by operating the switch.

As a basic operation of the mixer 10, the control unit 25, upon detecting through the lid detection device 31 that the cooking container 40 has been mounted on the body 20 and through the installation detection device 34 that the mixer 10 has been properly placed on the placement surface 80, functions the lock mechanism 35 by switch operation to prevent the cooking container from falling off or becoming misaligned, and drives the motor 21 to rotate the cooking implement 60. Then, the food ingredients in the cooking container 40 are cut or otherwise processed.

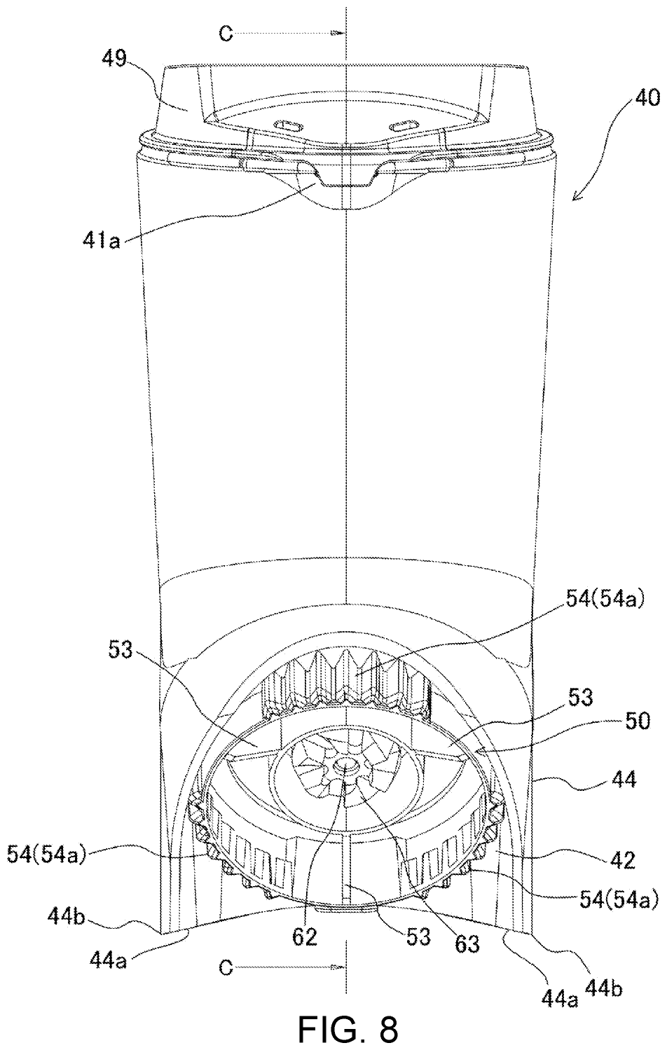

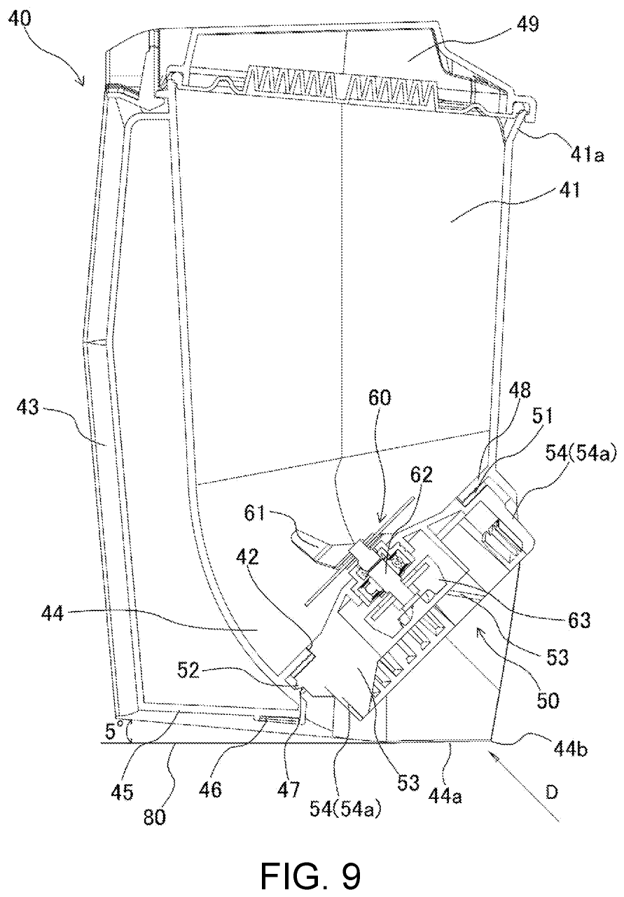

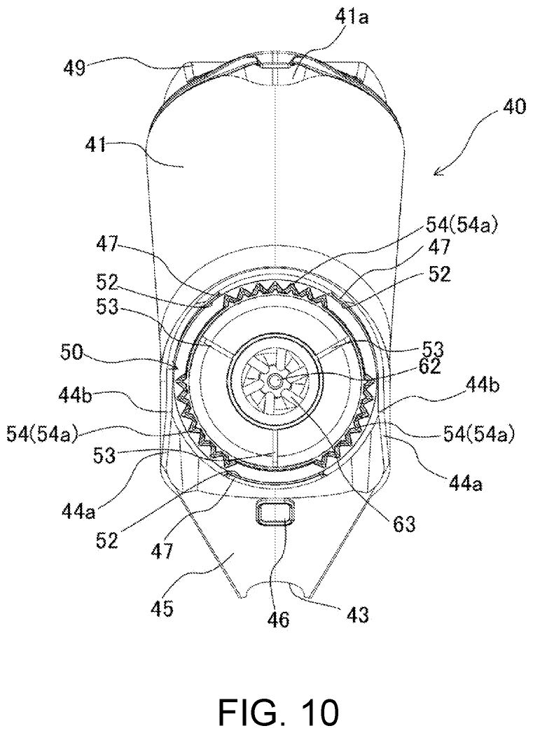

As shown in FIGS. 1 to 12, the cooking container 40 has a cup 41 into which food ingredients are put and the lid 49, with a handle 43 formed on the front side of the cup 41. The cup 41 is a cylindrical body extending in the vertical direction from approximately the center to the upper side. As shown in FIG. 9, a spout 41a with an outwardly projecting upper edge is formed on the rear side of the cup 41 opposite the handle 43. The lower portion of the cup 41 has a bent portion 44 that bends toward the inclined portion 29 of the body 20, that is, diagonally downward. As shown in FIG. 9, the bottom surface 44a orthogonal to the vertical direction of the cup 41 is formed below the bent portion 44. The tip of the bottom surface 44a, that is, the rear end edge, is a contact edge 44b. The contact edge 44b functions as a fulcrum N when the cooking container 40 is tilted from its placed state on the placement surface 80 toward the spout 41a side to pour food ingredients. In this embodiment, as shown in FIGS. 8 and 9, the contact edge 44b is provided at two locations on the left and right across a vertical plane including the handle 43, a cutter shaft 62 (to be described later), and the spout 41a.

Furthermore, the cooking container 40 has a bridge portion 45 protruding forward from the bottom surface 44a and connected to the handle 43 to reinforce the handle 43. In this embodiment, the bridge portion 45 is configured to extend laterally at an angle of 5° with respect to the bottom surface 44a of the cup 41, that is, at an angle of 85° with respect to the vertical direction of the cup 41. The receiving portion 46, in which the claw piece 35a of the lock mechanism 35 of the body 20 mentioned above fits, is recessed in the lower surface of the bridge portion 45.

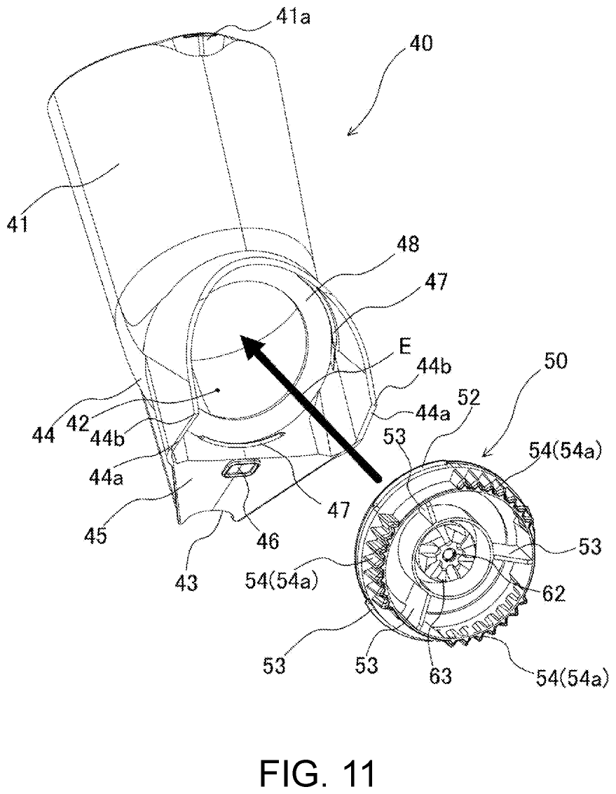

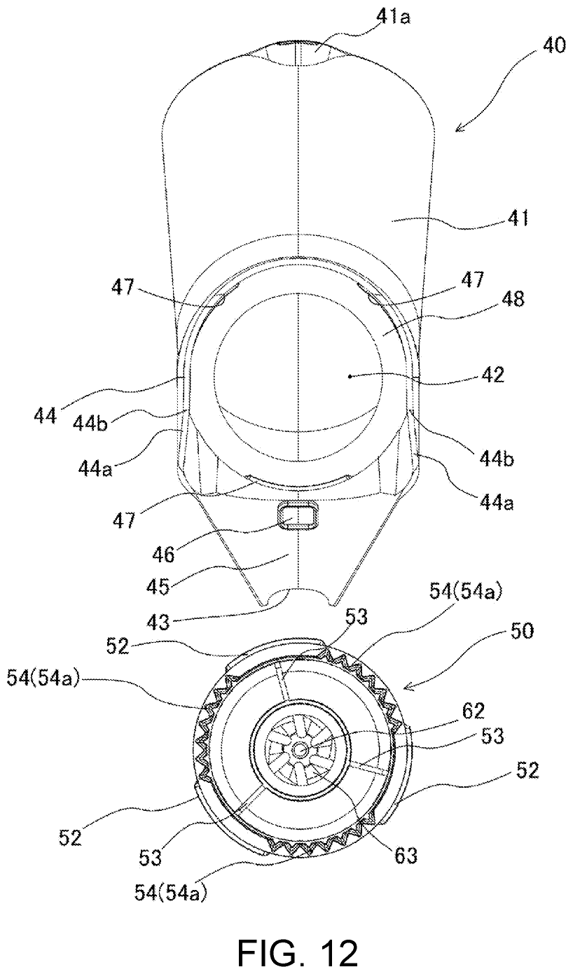

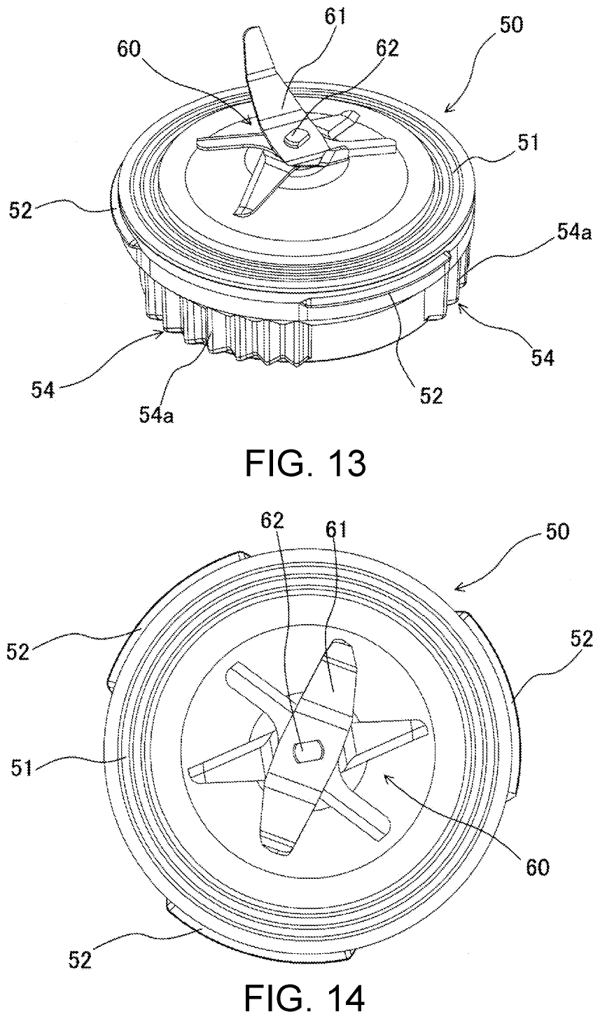

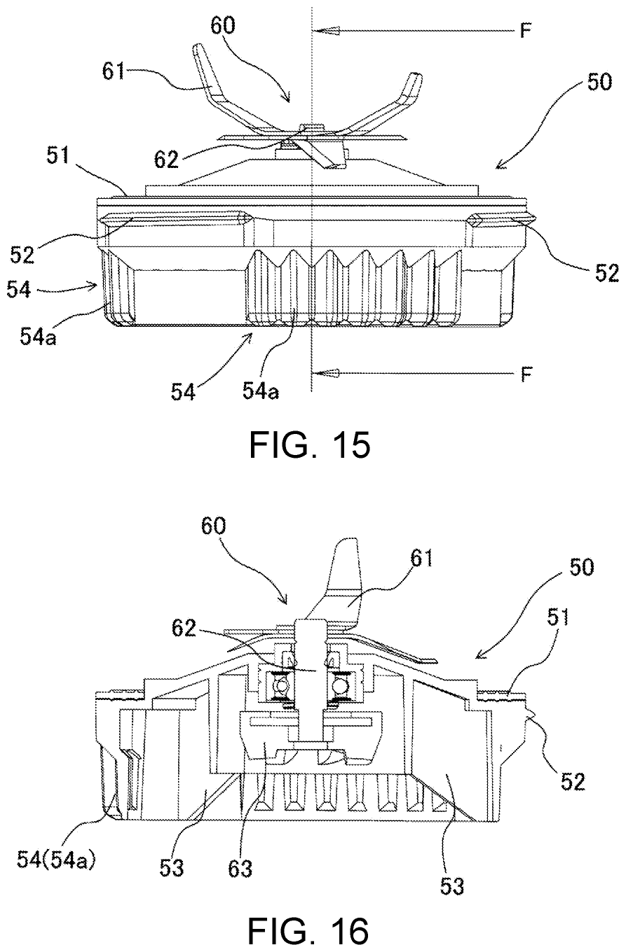

The bent portion 44 of the cup 41 has a cutter die mounting opening 42 that penetrates in a circular shape diagonally downward, as shown in FIGS. 11 and 12, and the cross-sectional circular cutter die 50 may be attached and detached. An arrow E in FIG. 11 indicates the mounting direction of the cutter die 50. As shown in FIGS. 13 to 16, the cooking implement 60 is rotatably disposed on the cutter die 50. The cooking implement 60 has, for example, a blade or a cutter 61 suitable for the cooking content, and the cutter shaft 62 extends downward from the cutter 61. The cutter shaft 62 penetrates through the cutter die 50 so as to be rotatable by a bearing or the like, and at its base end, a cooking implement-side coupling 63 is arranged. The cooking implement-side coupling 63 may engage with the body-side coupling 23 mentioned above.

As shown in FIG. 9, the cutter die 50 is mounted on the cutter die mounting opening 42 of the cup 41 such that the cooking implement 60 is arranged inside the cup 41. As shown in FIGS. 11 and 12, a flange 48 protrudes from the inner surface of the cutter die mounting opening 42 of the cup 41, and a cup-side meshing portion 47, which includes multiple screw threads with two or more threads, is provided outside the flange 48. In the drawing, the cup-side meshing portion 47 is triple-threaded.

Furthermore, as shown in FIGS. 13 to 16, the cutter die 50 is a bottomed cylindrical member with a seal member 51 arranged on the facing surface of the flange 48 of the cutter die mounting opening 42. On the peripheral surface of the cutter die 50, a cutter die-side meshing portion 52, which includes multiple screw threads with two or more threads that may engage with the multiple screw threads of the cup-side meshing portion 47 in a complementary shape, is formed. In the drawing, the cutter die-side meshing portion 52 is triple-threaded.

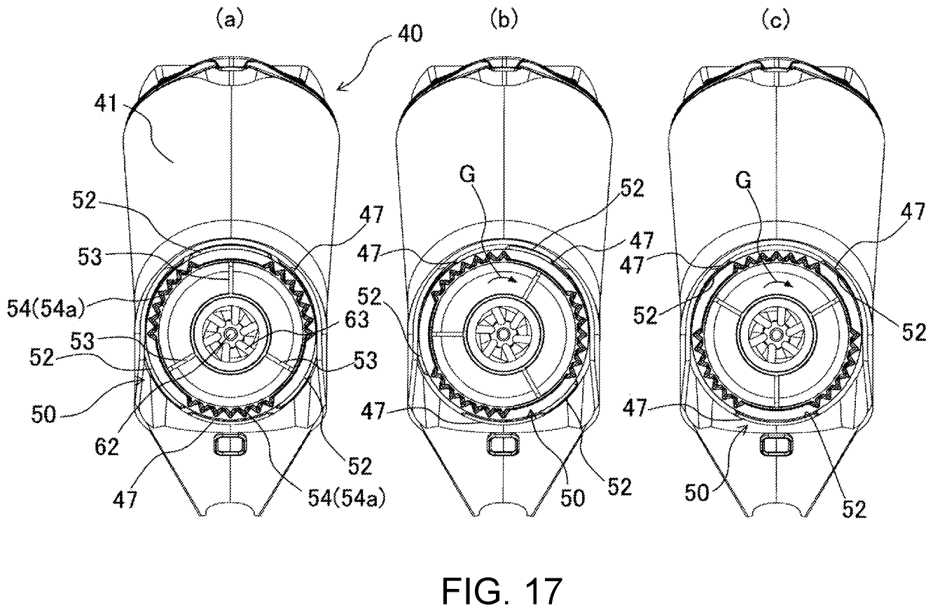

Since the cup-side meshing portion 47 and the cutter die-side meshing portion 52 each is multiple-threaded, as shown in (a) of FIG. 17, by aligning the tips of the external thread and internal thread of the multiple screw threads of the cup 41 and the cutter die 50, and then rotating the cutter die 50 relative to the cup 41 by 60°, as indicated by arrow G in (b) of FIG. 17 and (c) of FIG. 17, specifically by rotating the cutter die 50 clockwise, they may be engaged with each other. Figure (c) of 17 shows the state where the cutter die 50 is mounted on the cup 41. Moreover, the cutter die 50 mounted on the cup 41 may be removed by reversely rotating the cutter die 50 relatively by 60° in the case of triple screw threads, specifically by rotating the cutter die 50 counterclockwise. In the case of double screw threads, the relative rotation angle is less than or equal to 90°. In the case of double screw threads, since the relative rotation angle is larger than that of triple screw threads, there is a possibility that users may find it difficult to twist. However, with triple screw threads, since the relative twisting angle is only 60°, users may perform the rotating operation without any resistance. Moreover, in the case of double screw threads, since the distance between threads becomes longer, the contact pressure of meshing portions 47 and 52 becomes weaker and sealing performance is inferior compared to triple screw threads. Furthermore, if four or more screw threads are used, molding undercut increases, resulting in higher mold costs compared to triple screw threads. Thus, the present invention adopts triple screw threads.

Thus, unlike the prior art, it is not necessary to rotate the cup relative to the cutter die by more than 180°, and the cup 41 and the cutter die 50 may be easily attached and detached with a relative rotation angle of less than 180°.

Furthermore, since the cup 41 and the cutter die 50 are each multiple-threaded with two or more threads, and each external thread and internal thread is formed at equal intervals in the circumferential direction, the cutter die 50 does not tilt or twist when screwing the cutter die 50 onto the cup 41. Thus, the cutter die 50 may be mounted parallel to the flange 48 of the cup 41, and the seal member 51 may be compressed to seal the cup 41 watertight.

In this embodiment, the cutter die 50 has a finger hook portion 53 formed such that a user may hook their finger on the outer surface or the outer bottom surface side and the cutter die 50 may be relatively rotated to the cup 41 to be easily attached to and detached from the cup 41. In the illustrated embodiment, the finger hook portion 53 is a plurality of ribs formed on the inner surface of the cutter die-side engagement portion 54. By inserting their fingers between the ribs, the user may rotate the cutter die 50 without slipping and attach or detach it to or from the cup 41.

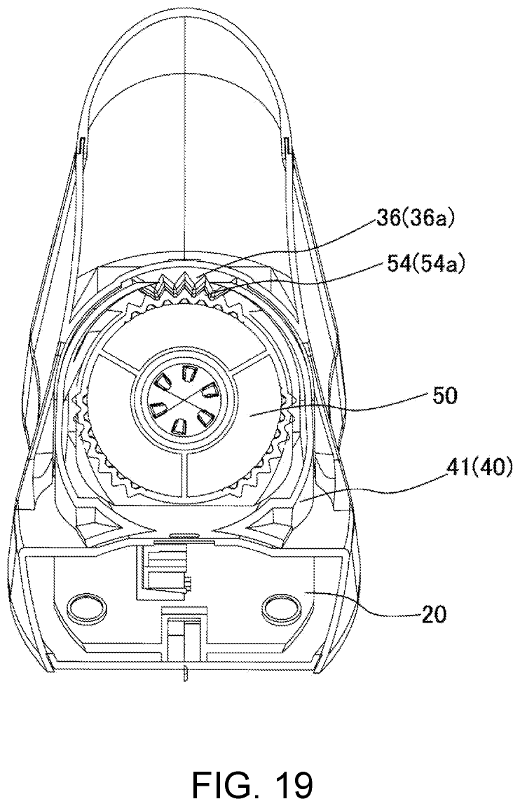

On the peripheral surface of the cutter die 50, as shown in FIGS. 11, 12, 13, and 15, the cutter die-side engagement portion 54 is formed below the cutter die-side meshing portion 52. On the other hand, as shown in FIG. 5, the body-side engagement portion 36 is provided on the inclined portion 29 of the body 20. The body-side engagement portion 36 is rotatable within a predetermined angular range relative to the inclined portion 29. Moreover, the cutter die-side engagement portion 54 and the body-side engagement portion 36 may be engaged, as shown in FIG. 19, by placing a cooking container 40 on the body 20.

Specifically, the cutter die-side engagement portion 54 and the body-side engagement portion 36 may each have a pointed gear shape at their tips. The cutter die-side engagement portion 54 is formed at three locations with 60° intervals, similar to the cutter die-side meshing portion 52, and has multiple gear portions 54a (seven peaks in the drawing).

On the other hand, as shown in FIGS. 4 to 6, the body-side engagement portion 36 is formed only on the upper side of the inclined portion 29 and has a gear portion 36a with fewer teeth than the gear portion 54a (four peaks in the drawing). The gear portion 36a protrudes obliquely downward from the upper side of the inclined portion 29 toward the front side, and the body-side engagement portion 36 itself is swingable around the body-side coupling 23 of the inclined portion 29.

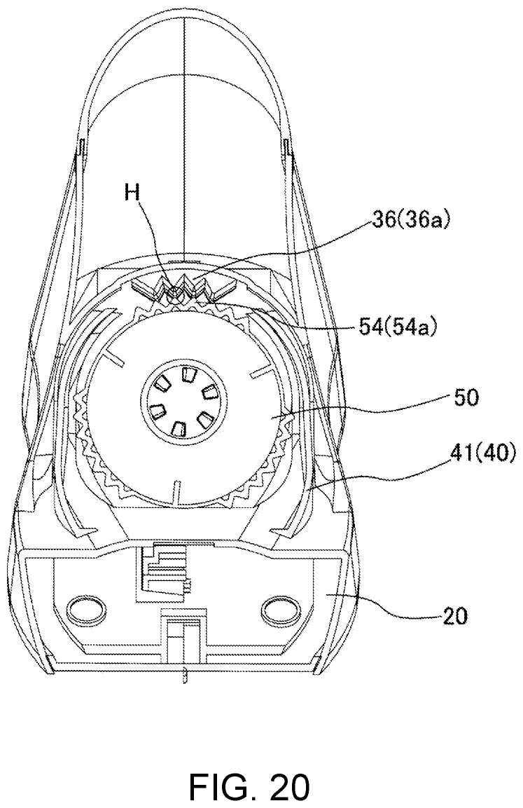

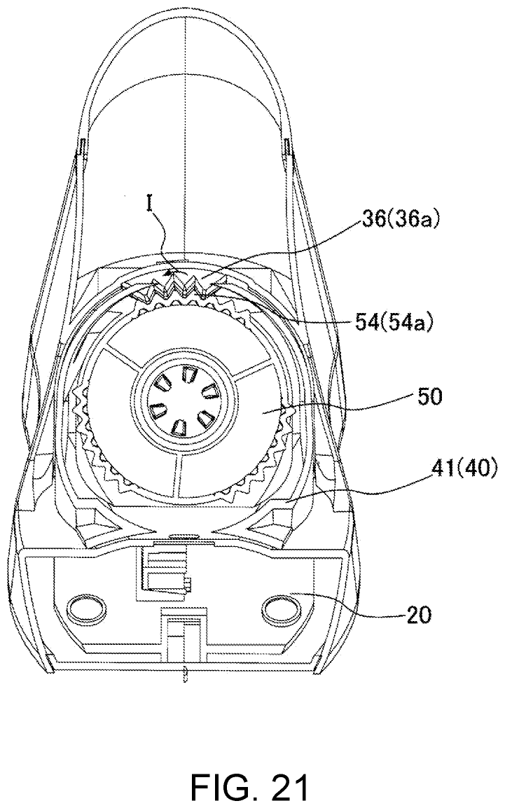

As described above, the body-side engagement portion 36 is swingable with respect to the body 20, and for the cutter die-side engagement portion 54, since the cutter die 50 is rotatable relative to the cup 41, the gear portions 36a and 54a may be adjusted slightly in angle. Accordingly, when placing the cooking container 40 on the body 20, even if the angles of the gear portions 54a and 36a of the cutter die-side engagement portion 54 and the body-side engagement portion 36 do not match and collide as shown in an encircled portion H in FIG. 20, the gear portion 54a of the cutter die-side engagement portion 54 will contact the gear portion 36a of the body-side engagement portion 36, and as shown by arrow I in FIG. 21, the body-side engagement portion 36 will swing to engage with the cutter die-side engagement portion 54.

By engaging the cutter die-side engagement portion 54 with the body-side engagement portion 36 (FIGS. 19 and 21), it is possible to prevent the cutter die 50 from loosening from the cup 41 due to vibration during cooking.

In the illustrated embodiment, the gear portion 36a of the body-side engagement portion 36 and the gear portion 54a of the cutter die-side engagement portion 54 are each mountain-shaped gears with 10° intervals, and the body-side engagement portion 36 is set to have a movable range of 5° to the left and right with respect to the body 20. Thus, even if the cup 41 is attached to the body 20 in a state where the tightening of the cutter die 50 to the cup 41 is loose (insufficient rotation) or tight (over-rotation), the cutter die-side engagement portion 54 may be locked by the body-side engagement portion 36 due to the swinging of the body-side engagement portion 36.

When the gear portions 36a and 54a are configured at the above-mentioned angles, a gap of approximately 0.05 mm opens between the flange 48 of the cup 41 and the cutter die 50 when the cup 41 and the cutter die 50 are loosened by 5°. However, the sealing performance may be ensured by the convex shape of the seal member 51 mounted on the cutter die 50. The seal member 51 is crushed when the cutter die 50 is attached to the cup 41, providing sealing performance, but it is preferable to form it at a height (for example, a convex shape of 0.5 mm) that may sufficiently seal the gap that occurs between a flange 58 and the cutter die 50.

In using the mixer 10 with the above configuration, first, as shown in FIGS. 11 and 12, the cutter die 50 is attached to the cup 41 from a state where the cutter die 50 is removed. The cutter die 50 only needs to be brought close to the cup 41 in the direction of arrow E shown in FIG. 11, aligned with the cutter die mounting opening 42 of the cup 41, and relatively rotated (arrow G) with respect to the cup 41 as shown in FIG. 17 by inserting a finger between the finger hook portions 53. As a result, the cutter die-side meshing portion 52, which consists of multiple screw threads, of the cutter die 50 is screwed into the cup-side meshing portion 47 of the cup 41, and the cutter die 50 is mounted on the cup 41 as shown in FIGS. 8 and 9. As for the cutter die 50, the meshing portions 47 and 52 of the cup 41 and the cutter die 50 are formed as multiple screw threads with two or more threads, thus after aligning the tips of the external thread and internal thread ((a) of FIG. 17), by relatively rotating the cutter die 50 with respect to the cup 41 at a predetermined angle ((b) of FIG. 17), they may be meshed with each other ((c) of FIG. 17). The finger hook portion 53 allows for an appropriate attachment of the cutter die 50 to the cup 41 without slipping. When the meshing portions 47 and 52 are triple-threaded, the relative rotation angle is less than or equal to 60°.

The cutter die mounting opening 42 is formed in the bent portion 44 of the cup 41 and is inclined with respect to the vertical direction. The inclination angle is the same as that of the inclined portion 29 of the body 20, which is 45°. Thus, as shown in FIG. 9, the cutter die 50 attached to the cup 41 is also arranged in a state include in a non-vertical direction such that the rotation center of the cutter shaft 62 becomes a non-vertical axis.

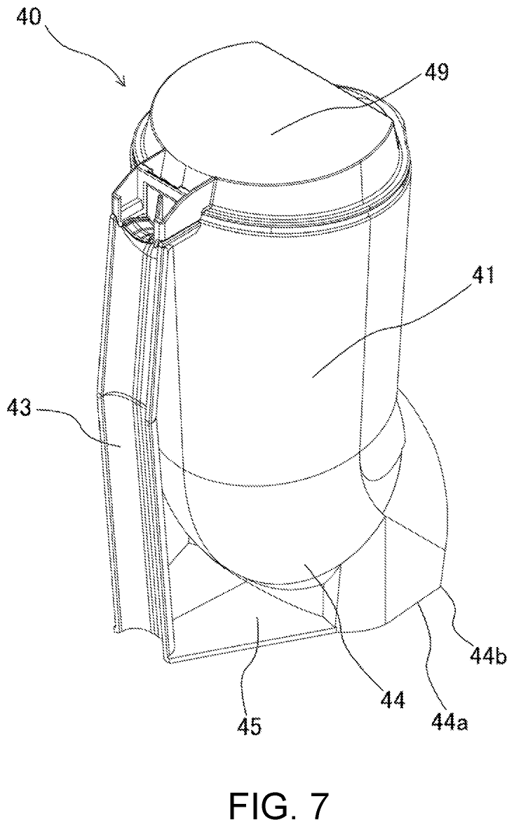

Moreover, as shown in FIG. 9, the bottom surface 44a of the cup 41 is orthogonal to the vertical direction of the cup 41, and the bridge portion 45 is formed with a shape inclined by 5° with respect to the bottom surface 44a. Thus, as shown in FIGS. 7 and 9, the cup 41 may be placed upright on the placement surface 80 such as a table. FIG. 9 shows a state in which the bottom surface 44a is placed upright so as to contact the placement surface 80. Furthermore, when the bridge portion 45 is erected to be brought into contact with the placement surface 80, the cup 41 is inclined by 5°.

In this state, the cooking container 40 has the lid 49 removed, food ingredients (not shown) are placed into the cup 41, and the lid 49 is closed.

Then, as shown in FIGS. 5 and 6, the cooking container 40 is faced with the body 20. At this time, as shown in FIG. 4, when the body 20 is properly placed on the placement surface 80, the installation detection device 34 detects the placement surface 80 and the operation member 34a retracts to the body 20 side.

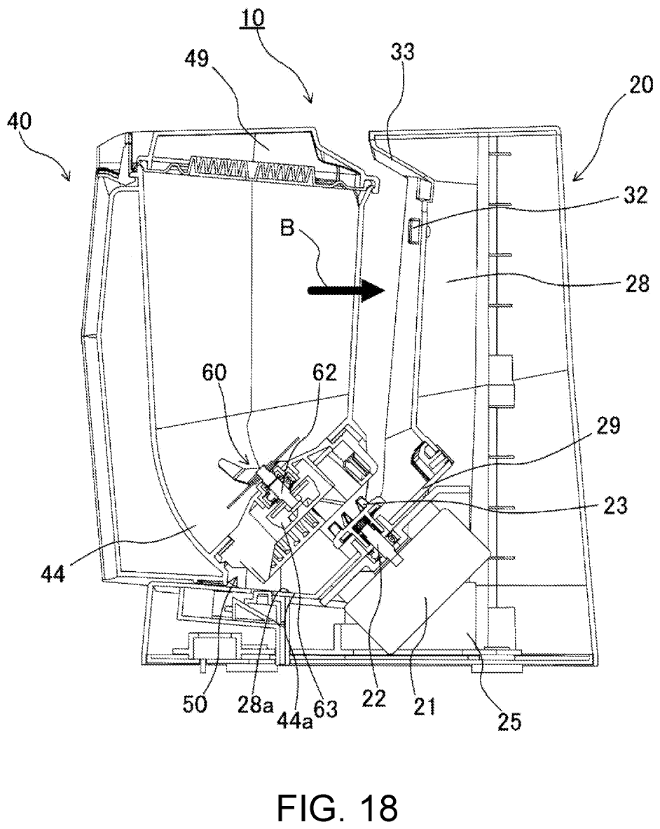

Next, as indicated by arrow B in FIGS. 5, 6, and 18, the cooking container 40 is brought closer to the body 20. In this embodiment, since the body 20 is inclined such that the upper surface 28a of the horizontal portion 28 slopes downward by 5° toward the rear side, the cooking container 40 slides on the upper surface 28a and is pressed to the rear side, and moves diagonally downward at a 5° inclination. As a result, the cooking container 40 enters such that the bent portion 44 fits into the inclined portion 29 of the body 20, and the lid 49 is mounted on the body with a desired mounting angle regulated by contacting the lower surface of the guide portion 33 of the vertical portion 27 of the body 20 (FIGS. 1 to 4). At the same time, the body-side coupling 23 engages with the cooking implement-side coupling 63, and the motor 21 is connected to the cutter shaft 62 (see FIG. 4). In the present invention, there is no need to lift the cooking container 40 upward as in conventional methods to mount it on the body 20; it may be easily done by simply sliding it in a lateral direction (arrow B). Thus, even if the cooking container 40 is heavy due to food ingredients, the mounting operation of the cooking container 40 can be easily performed.

By bringing the cooking container 40 closer to the body 20, as shown in FIG. 19, the cutter die-side engagement portion 54 of the cutter die 50 engages with the body-side engagement portion 36 of the body 20 as shown in FIG. 19. As shown in FIG. 20, even if the angles of the gear portions 54a and 36a of the cutter die-side engagement portion 54 and the body-side engagement portion 36 do not match (the encircled portion H in FIG. 20), by pushing the cooking container 40 as it is, the gear portions 54a and 36a come into contact with each other, causing the body-side engagement portion 36 to rotate slightly (arrow I) as shown in FIG. 21, and the cutter die-side engagement portion 54 and the body-side engagement portion 36 engage.

At this time, even if the cooking container 40 is pushed strongly, since the buffer member 32 (see FIGS. 5 and 6) is arranged on the vertical portion 27 of the body 20, as shown in FIG. 4, the buffer member 32 comes into contact with the cooking container 40, and the impact is mitigated.

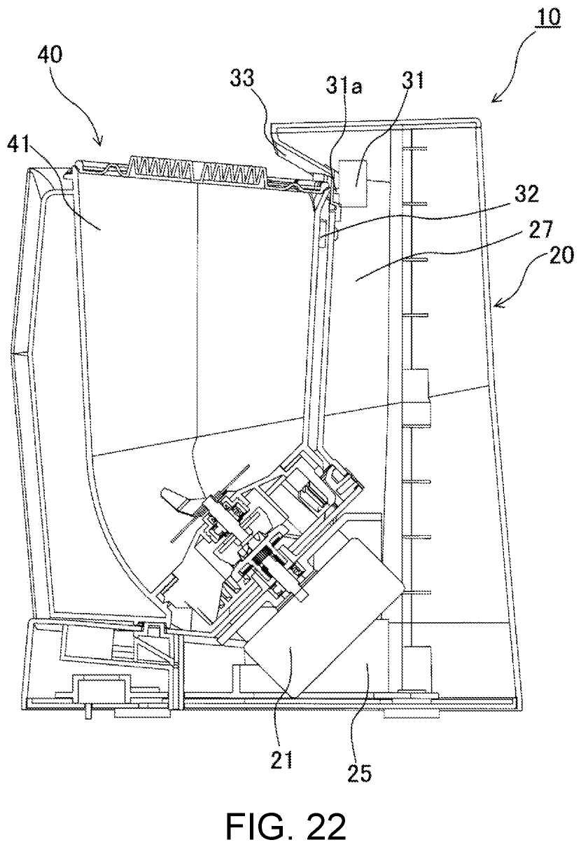

When the cooking container 40 is properly mounted on the body 20, the lid detection device 31 detects the lid 49. However, if the lid 49 is forgotten to be attached to the cooking container 40, as shown in FIG. 22, since the operation member 31a is not pushed by the lid 49, the lid detection device 31 detects that the lid 49 is not attached or the cooking container 40 is not properly mounted. The detection information of the lid detection device 31 is sent to the control unit 25. The control unit 25 can achieve a configuration that enhances safety by preventing the motor 21 from rotating while the lid detection device 31 does not detect the lid 49.

Then, the mixer 10 is driven by operating a switch (not shown). When the control unit receives the switch operation, it first determines whether the lid detection device 31 detects that the cooking container 40 has been properly mounted on the body 20 or whether the installation detection device 34 detects that the body 20 is grounded on the placement surface 80. If either or both cannot be detected are unsuccessful, the event may be reported with an LED or a buzzer sound.

When the control unit 25 receives the switch operation in a state where both of the above are detected, it first activates the lock mechanism 35 and inserts the claw piece 35a of the lock mechanism 35 into the receiving portion 46 of the cooking container 40 as shown in FIG. 4, engaging the cooking container 40 with the body 20. This prevents the cooking container 40 from falling off from the body 20 and misalignment of the cup 41. By preventing misalignment of the cup 41, the fitting state of the couplings 23 and 63 may be maintained well, which reduces noise, vibration, and damage that may occur during cooking.

In this state, the control unit 25 drives the motor 21 and rotates the cutter shaft 62 and the cutter 61 through the couplings 23 and 63. As a result, the food ingredients in the cup 41 are subjected to cooking such as crushing by the cutter 61. In this embodiment, the body 20 is inclined such that the upper surface 28a of the horizontal portion 28 slopes downward by 5° toward the rear side. Thus, when the cup 41 is mounted on the body 20 and energized, even if the cup 41 and the body 20 vibrate, the cup 41 moves downward along the slope of the upper surface 28a of the horizontal portion 28 toward the vertical portion 27, preventing the cup 41 from separating from the body 20 and maintaining a good fit between the couplings 23 and 63.

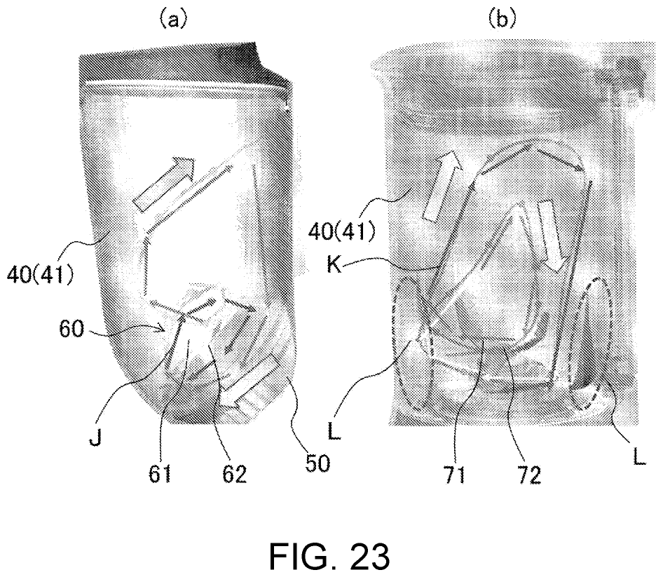

(a) of FIG. 23 is an explanatory diagram in which, when food ingredients are cooked in the mixer 10 including the cutter 61 rotating in an inclined plane by the inclined cutter shaft 62 in a cup 41 having the bent portion 44 according to the present invention, the movement of the food ingredients is analyzed by fluid analysis and the direction of movement is indicated by line J. On the other hand, (b) of FIG. 23 is an explanatory diagram showing the movement direction of food ingredients when the food ingredients are cooked by a cutter 71 rotating in a horizontal plane by a conventional vertical cutter shaft 72, indicated by line K. Referring to the drawings, in (a) of FIG. 23, as indicated by arrow J, the food ingredients make a large turn while contacting the cutter 61 in an inclined plane parallel to the cutter die 50 and exhibit a gentle upward flow. Moreover, it may be seen that the upper food ingredients are pulled back downward by the rotation of the inclined cutter 61 and contact the cutter 61 again for turning. On the other hand, in (b) of FIG. 23, as indicated by arrow K, it may be seen that the food ingredients move significantly in the vertical direction and has accumulated at the bottom peripheral portion of the cup 41 indicated by an encircled portion L. From these comparisons, it may be determined that the mixer 10 of the present invention may increase the number of times food ingredients contact the cutter 61 and improve cooking performance such as cutting. Furthermore, since the up-and-down movement of food ingredients in the mixer 10 of the present invention is gentle, it may reduce opportunities for contact with air and suppress inclusion of air bubbles. This makes it possible to suppress the progression of oxidation of food ingredients and further suppress heat generation due to friction between food ingredients, preventing deterioration of food ingredients.

As indicated by arrow M in FIG. 24, when the mixer 10 tilts during cooking and lifts off from the placement surface 80, the installation detection device 34 detects the tilt and floating of the body 20. In this embodiment, the operation member 34a protrudes. As a result, the control unit 25 controls to stop the motor 21, which can prevent food ingredients from spilling out of the cooking container 40 and enhance safety.

When the cooking is completed, the switch is turned off. As a result, the control unit stops driving the motor 21 and activates the lock mechanism 35 to retract the claw piece 35a from the receiving portion 46, making it possible to detach the cooking container 40 from the body 20. To remove the cooking container 40 from the body 20 in this state, simply grasp the handle 43 of the cooking container 40 and slide it in the horizontal direction (opposite to arrow B in FIG. 5). In this embodiment, since the body 20 is tilted such that the upper surface 28a of the horizontal portion 28 slopes downward by 5° toward the rear side, the cooking container 40 may be removed by pulling it diagonally upward with a 5° inclination toward the front side while sliding on the upper surface 28a. Since there is no need to lift the cooking container 40 upward during removal as in attachment, there is an advantage that even if the cooking container 40 becomes heavier due to food ingredients, the removal operation can be easily performed.

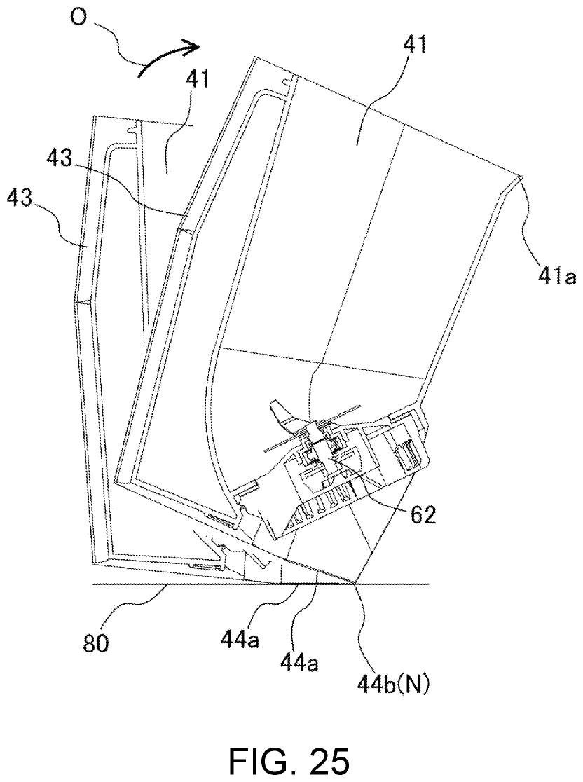

Then, the cooking container 40 is opened by opening the lid 49, and the cooked food ingredients are poured out. At this time, the handle 43 may be grasped to lift the cooking container 40 and tilt it toward the spout 41a side to pour out the cooked food ingredients. Moreover, if the total weight of the cooking container 40 and food ingredients is heavy, it is difficult to lift and pour the cup 41. Thus, in the present invention, as shown in FIG. 25, while the cooking container 40 is placed on the placement surface 80, the cooking container 40 may be tilted (arrow O) with the contact edge 44b provided at the tip of the bottom surface 44a of the cup 41 as the fulcrum N so as to pour out the food ingredients. Since the contact edge 44b is provided at two locations on both left and right sides across the spout 41a as shown in FIG. 8, the cooking container 40 can be prevented from wobbling left and right when tilted, providing stable pouring operation with less force.

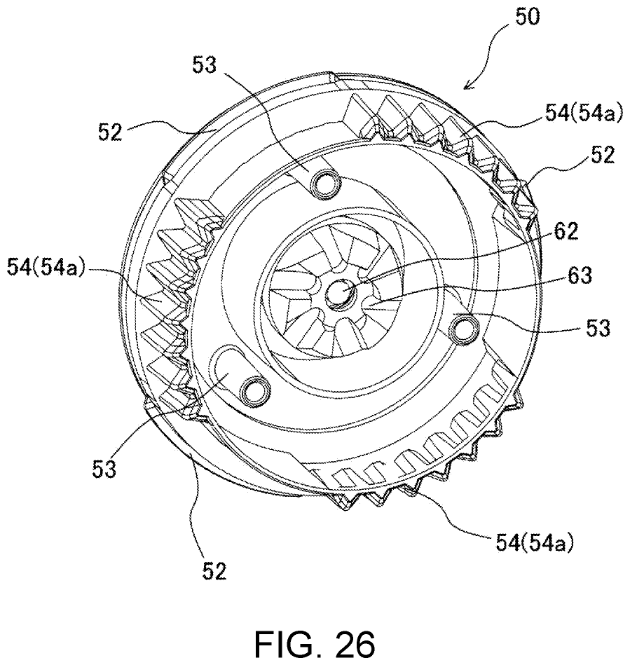

When maintaining the cooking container 40, as shown in FIGS. 11 and 12, the user can simply hook their fingers on the rib-shaped finger hook portion 53 formed on the cutter die 50 and twist the cutter die 50 relative to the cup 41. This allows the cutter die 50 to be easily removed without slipping. FIG. 26 shows a modified example in which the finger hook portion 53 is in the form of a cylindrical boss. In this form as well, the user can easily attach and detach the cutter die 50 by hooking their fingers.

The above description is for the purpose of explaining the present invention and should not be construed as limiting or narrowing the scope of the invention as set forth in the claims. Furthermore, it is of course possible to make various modifications to the components of the present invention within the technical scope described in the claims, without being limited to the above-described embodiments.

For example, in the above-described embodiment, the cooking container 40 is structured to be mounted by pressing downward at a 5° angle relative to the body 20 and removed by lifting upward at an angle. In contrast, the upper surface 28a of the horizontal portion 28 of the body may be formed horizontally, and a tilt mechanism may be provided in the body 20 to allow the motor 21 and the output shaft 22 to tilt. When attaching and detaching the cooking container 40, the tilt mechanism may be operated to mount and remove the cooking container 40 in a horizontal direction (with a 0° inclination). This allows the cooking container 40 to be attached and detached by horizontal sliding without requiring pressing down or lifting up actions, achieving a compact configuration in the height direction.

### REFERENCE SIGNS LIST

10 Mixer (Cooking appliance)
20 Body
21 Motor
31 Lid detection device
32 Buffer member
33 Guide portion
34 Installation detection device
35 Lock mechanism
36 Body-side engagement portion
41 Cup
47 Cup-side meshing portion
49 Lid body
50 Cutter die
52 Cutter die-side meshing portion
53 Finger hook part
54 Cutter die-side engagement portion
60 Cooking implement

1. A cooking device, comprising:
a cooking container that has a cooking implement and that is equipped with a cup to which a lid is attachable;
a body to which the cooking container is attached and which causes the cooking implement to rotate,
wherein the cooking container is attached to and detached from the body in a non-vertical direction.

2. The cooker according to claim 1,
wherein the cooking container is attachable and detachable with respect to the body in a non-vertical direction of 0° to 75° relative to a horizontal direction.

3. The cooker according to claim 1,
wherein the body has a lock mechanism that prevents the cooking container from falling off and/or displaced.

4. The cooker according to claim 1,
wherein the body has an installation detection device that detects that the body is separated from a placement surface while the cooking implement is rotating.

5. The cooker according to claim 1,
wherein a rotation center of the cooking implement is inclined in a non-vertical direction with the cooking container attached to the body, and
the body rotates the cooking implement about a non-vertical axis.

6. The cooker according to claim 1,
wherein the cooking container has an upper edge side extending in a vertical direction.

7. The cooker according to claim 1,
wherein the body has a lid detection device that detects the lid with the cooking container attached.

8. The cooker according to claim 1,
wherein a buffer member is provided between the body and the cooking container to prevent the cooking container from being excessively pushed with respect to the body in a non-vertical direction.

9. The cooker according to claim 1,
wherein the cooking container has a spout with an upper edge protruding outward, and
a bottom surface of the cooking container has two contact edges that, when the cooking container is tilted toward the spout from a state of being placed on a placement surface, come into contact with the placement surface.

10. The cooker according to claim 2,
wherein the body has a lock mechanism that prevents the cooking container from falling off and/or displaced.

11. The cooker according to claim 2,
wherein the body has an installation detection device that detects that the body is separated from a placement surface while the cooking implement is rotating.

12. The cooker according to claim 2,
wherein a rotation center of the cooking implement is inclined in a non-vertical direction with the cooking container attached to the body, and
the body rotates the cooking implement about a non-vertical axis.

13. The cooker according to claim 2,
wherein the cooking container has an upper edge side extending in a vertical direction.

14. The cooker according to claim 2,
wherein the body has a lid detection device that detects the lid with the cooking container attached.

15. The cooker according to claim 2,
wherein a buffer member is provided between the body and the cooking container to prevent the cooking container from being excessively pushed with respect to the body in a non-vertical direction.

16. The cooker according to claim 2,
wherein the cooking container has a spout with an upper edge protruding outward, and
a bottom surface of the cooking container has two contact edges that, when the cooking container is tilted toward the spout from a state of being placed on a placement surface, come into contact with the placement surface.
